(19) United States
(12) Patent Application Publication
(10) Pub. No.: US 2006/0056897 A1
(43) Pub. Date: Mar. 16, 2006

(54) Thermal transfer ribbon for forgery-prevention

(75) Inventors: Sang-Cheon Park, Seoul (KR); Sun-O Lee, Gyeonggi-do (KR); Jung-Seok Seo, Daejeon Metropolitan City (KR); Young-Tac Kim, Seoul (KR)

Correspondence Address: DICKSTEIN SHAPIRO MORIN & OSHINSKY LLP, 2101 L Street, NW, Washington, DC, 20037, US

(73) Assignee: C & I Systems Co., Ltd., Seoul 153-803 (KR)

(21) Appl. No.: 10/542,878

(22) PCT Filed: Jan. 29, 2004
(86) PCT No.: PCT/KR04/00155

§ 371 Date: Jul. 20, 2005

(30) Foreign Application Priority Data
Jan. 29, 2003 (KR) 10-2003-0005783
Jan. 29, 2003 (KR) 10-2003-0005782

(51) Int. Cl. B41M 5/26

(52) U.S. Cl. 400/241

(57) ABSTRACT

A thermal transfer ribbon for forgery prevention comprising: a substrate film; a heat-resistant layer coated on one surface of the substrate film for preventing thermofusibility with a thermal transfer head; one or more than one thermofusible ink layer, or one or more then one thermofusible ink layer and one or more than one protective later coated on the other surface of the substrate just by one layer; and if necessary one or more than one sublimable dye layer, wherein the thermofusible ink layer and/or protective layer contain luminescence, invisible fluorescence or mixture thereof, such that a security function for preventing forgery and alteration is added simultaneously with the printing by using the ribbon equipped with the security function to a printing material in one process.

### FIELD OF THE INVENTION

The present invention relates to a thermal transfer ribbon having a security function. More particularly, the present invention relates to a thermal transfer ribbon printable with color images, characters, text and the like and including a security function that prevents forgery, falsification and alteration in conjunction with addition of luminescence, invisible fluorescence or a mixture thereof.

### BACKGROUND OF INVENTION

It has been a recent trend for an individual's personal information to be recorded on plastic cards such as identification cards, credit cards, communication cards and the like. Meanwhile, in order to record one's personal information, characters or bar codes are printed along with images as circumstances may require, at which time thermal transfer ribbons are usually used as printing media.

The thermal transfer ribbon generally comprises a substrate of Polyethylene terephthalate (PET) film, a thin heat-resistant layer coated on one surface of the substrate for preventing thermofusibility between the substrate and a thermal transfer head, and a thermofusible ink layer or a thermofusible ink layer and a sublimable dye layer coated on the other surface of the substrate.

A thermal transfer printing method using the thermal transfer ribbons is available as a main stream method for application in printing commercials such as small outdoor advertising media, election posters, stickers, calendars and pamphlets, and labels for foods, pharmaceuticals and paints, and individual recognitions such as name cards and identification cards.

However, there is a disadvantage in the printing method using the thermal transfer ribbons thus described in that printed face images are exposed to frequent friction or abrasion to cause printed records to be easily erased, thereby giving rise to a problem in the management of an individual's personal information. The problem can be overcome by applying a thermal transfer protective layer and can be further overcome by laminating a hologram for providing a security function.

For example, in Korean laid open utility model application No. 1999-007692, a thermal transfer ribbon used for ordinary paper and facsimile paper is disclosed where the ribbon comprises a PET layer, a beat-resistant layer coated on one surface of the PET layer, a wax layer coated on the other surface of the PET layer with carbon material and a matte layer having the same color as the wax layer and disposed between the PET layer and the wax layer, whereby it is difficult to recognize printed images remaining on used thermal transfer ribbon having passed a thermal sensitive head to thereby prevent information from being misappropriated by a third party.

Furthermore, in Korean patent No. 10-0184352, where a thermal transfer protective ribbon comprises a releasing layer, a transparent protective resin layer and an adhesive layer, each being coated in that order on a substrate, the thermal transfer protective ribbon is further coated with a transparent fluorescent pattern layer containing fluorescent colors on the adhesive layer.

However, there is a drawback in the invention of Korean patent No. 10-0184352 thus described in that the process for providing a forgery prevention function is too complicated because a two stage process is required where images and characters are initially transferred to a receiving material containing plastic, and a protective ribbon disposed with a transparent protective resin layer having a transparent fluorescent pattern is secondly superimposed and transferred onto the surface of the receiving material.

There is another drawback in that a simple application of a laminating additional means of protective layers or a hologram without providing a security function to a thermal transfer ribbon per se or a printed matter does not adequately prevent forgery or alteration of an individual's personal information.

The thermal transfer ribbon of the present invention has been developed to provide a printed matter per se with a security function by way of addition of luminescence, invisible fluorescence or mixture thereof to a thermofusible ink layer of the thermal transfer ribbon and a forgery prevention function at the same time while the ribbon is being printed.

The present invention is provided to overcome the aforementioned drawbacks and it is an object of the present invention to provide a thermal transfer ribbon configured to add luminescence, invisible fluorescence or mixture thereof to the thermal transfer ribbon for a supplemented security function to thereby prevent forgery and alteration.

It is another object of the present invention to provide a thermal transfer ribbon configured to print desired images and add a security function on a receiving material in one process.

It is still another object of the present invention to provide a thermal transfer ribbon configured to print a security function on various receiving materials including plastic, pulp paper, synthetic paper and the like.

### SUMMARY OF THE INVENTION

In accordance with a preferred embodiment of the present invention, a thermal transfer ribbon for forgery and counterfeit prevention comprises: a substrate film; a heat-resistant layer coated on one surface of the substrate film for preventing thermofusibility between the substrate and a thermal transfer head; one or more than one thermofusible ink layer, or one or more than one thermofusible ink layer and one or more than one protective layer coated on the other surface of the substrate film just by one layer; and if necessary one or more than one sublimable dye layer, wherein the thermofusible ink layer and/or protective layer include luminescence, invisible fluorescence or mixture thereof.

In accordance with another embodiment of the present invention, a thermal transfer ribbon for forgery prevention comprises; a substrate film; a heat-resistant layer coated on one surface of the substrate film for preventing thermofusibility with a thermal transfer head; one or more than one thermofusible ink layer formulated on the other surface of the substrate film just by one layer, and if necessary, one or more than one protective layer and/or one or more than one sublimable dye layer, wherein the thermofusible ink layer includes luminescence, invisible fluorescence or mixture thereof.

In still another embodiment of the present invention, a thermal transfer ribbon for forgery prevention comprises: a substrate film; a heat-resistant layer coated on one surface of the substrate film for preventing thermofusibility with a thermal transfer head; and one or more than one thermofusible ink layer and one or more than one protective layer, one or more than one sublimable dye layer and one or more than one protective layer, or one or more than one thermofusible ink layer and one or more than one sublimable dye layer and one or more than one protective layer formulated on the other surface of the substrate film just by one layer, wherein the protective layer includes luminescence, invisible fluorescence or mixture thereof.

Preferably, the luminescence and the invisible fluorescence act as a security function for preventing forgery and alteration, and may be included in the thermofusible ink layer and/or the protective layer of the thermal transfer ribbon.

The luminescence means a substance having a capability of storing light in a bright place and illuminating the light in a dark place, and may be any one of luminescence pigments and luminescence dyes recognized in the related field. Preferably, the luminescence pigment is Panax Green FB 900, Panax Blue FB 800 or the like manufactured by Ukseung Chemical Company.

The invisible fluorescence is a special substance having a capacity of appearing transparent in the visible region and brightly showing colors under ultraviolet light. Preferably, the invisible fluorescence is Panax Red PKS-225, Panax Green PKS-235, Panax Blue PKS-245 or the like manufactured by Ukseung Chemical Company.

Meanwhile, preferably, the content of the luminescence, invisible fluorescence or combination thereof is in the range of 0.5-50 weight % based on the total weight of the thermofusible ink layer or protective layer.

Preferably, the substrate of thermal transfer ribbon according to the present invention is made of plastic film such as PET film, Polyamide film, Polyvinyl Chloride (PVC) film, Polyethylene film, Polypropylene film, Polyimide film, Polysulfone film, or Polycarbonate film and preferably, the substrate film ranges in thickness thereof from 3 to 20 μm.

A heat-resistant and releasing layer may be formed on a thermal head contacting surface of the substrate in order to prevent deformation of the substrate film by contact with the high temperature-generating thermal head and to improve a releasability between the thermal head and the substrate film. Substances used for these purposes may include Carboxylate, Sulfonate, Phosphate, Aliphatic amine salt, Polyoxyethylene alkyl ester, Silicon oil, Synthetic oil and the like.

The thermofusible ink layer formed on the substrate at the opposite side of the heat-resistant layer and addable by luminescence and/or invisible fluorescence may include an inic layer, an ink layer and an adhesive layer formed on the upper surface of the ink layer, or an ink layer and an adhesive layer formed on the upper surface of the ink layer and a thermal releasing layer formed on the lower surface of the ink layer. The ink layer may include a coloring agent, binder resin, wax, additive and the like. Organic or inorganic pigment or dyestuff are usable for coloring agent. Acrylic resin. Polyester, Epoxy resin, Chlorovinyl-acetate vinyl Copolymer, Polyvinyl butyral resin and the like are usable for binder resin. Carnauba wax, Paraffin wax, Polyethylene wax and the like are usable for wax.

Meanwhile, the luminescence and/or invisible fluorescence according to the present invention may be added to a protective layer. The protective layer formed on a substrate at the opposite side of the heat-resistant layer serves to protect information including images formed at a receiving material by way of a thermofusible ink layer and/or a sublimable dye layer. The protective layer may include a thermally transferrable layer, a thermally transferrable layer and an adhesive layer formed on the upper surface of the thermally transferrable layer, or a thermally transferrable layer, an adhesive layer formed on the upper surface of the thermally transferrable layer and a thermal releasing layer disposed on a lower surface of the thermally transferrable layer for assisting releasability and durability after printing.

Resins such as Melamine resin, Acrylic resin, Polyester, Polyurethane each having an excellent transparency, abrasion-resistance and drug-resistance may be usable for the thermally transferrable layer. The thickness of the thermally transferrable layer is preferably in the range of 0.2-10 μm. The thermally transferrable layer may be added by a filler such as Silica or Alumina within a scope of not hurting the transparency in order to improve a cutting property in the transfer process. Furthermore, lubricants such as Polyethylene wax or Silicon oil may be added for improving abrasion-resistance or slippage property.

Resins having an excellent thermal adhesion property such as Acrylic resin, Polyvinyl chloride, Vinylchloride-vinylacetate copolymer, Polyester and the like may be used for the adhesive layer. The thickness of the adhesive layer is preferably in the range of 0.2-4 μm. The thermally transferrable layer or the adhesive layer may be added by an ultraviolet absorber for providing resistance to light.

In addition, a dye layer is formed on the same layer as that of the thermofusible ink layer for printing color images. The dye layer includes a sublimation dye, binder resin and other additives. The sublimation dyestuff includes three colors of yellow dye, magenta dye and cyan dye.

Macrolex Yellow 6G, MS Yellow VP, Kayaset Yellow A-G and the like may be used for the yellow dyestuff. MS Magenta VP, Kayaset Red 130, Waxoline Red YP-FW, MS Red G and the like may be used for the magenta dyestuff. Waxoline Blue AP-FW, Kayaset Blue 714, MS Blue 100 and the like may be used for the cyan dyestuff.

Furthermore, resins such as Ethyl cellulose resin, Polyvinyl butyral resin, Polyvinyl acetal resin, Polyvinyl chloride resin, each having excellent heat-resistance and migration of dye may be used for the binder resin.

The dyestuff, binder resins and additives such as a releasing agent may be solved or dispersed in an appropriate solvent for manufacturing ink for the dye layer. The ink is coated on a substrate by way of a Gravure printing method to form a sublimable dye layer of yellow, magenta and cyan. Preferably, a dry coated amount is in the range of 0.5-2.0 g/m², and preferably, dyestuff content in the dye layer is in the range of 20-60 weight %.

An anchor layer containing the same dyestuff as that of the dyestuff layer may be coated for improving adhesiveness between the dyestuff layer and the substrate. However, if the content thereof is too high, the adhesiveness between the dyestuff layer and the anchor layer may be weakened such that it is preferred that the dry coated amount is in the range of 0.05-1.5 g/m².

As a receiving material on which images are formed by the heat of the thermal transfer head by being brought into contact with the thermal transfer ribbon, a dye-receptive plastic film such as polyester may be used by itself, and a dye-non-receptive plastic film, paper, synthetic paper or the like may be used with a receptive layer having a dyestuff receptivity.

Preferably, the receptive layer is largely composed of resin with a dyestuff receptivity, and various additives may be included depending on the objective. Preferably, the thickness of the receptive layer is in the range of 5-50 μm.

### BRIEF DESCRIPTION OF THE DRAWINGS

For a better understanding of the nature and objects of the present invention, reference should be made to the following detailed description with the accompanying drawing, in which:

FIG. 1 is a schematic block drawing for illustrating a construction of a thermal transfer ribbon according to all embodiment of the present invention.

### DETAILED DESCRIPTION OF THE PREFERRED EMBODIMENT

A thermal transfer ribbon according to the preferred embodiment of the present invention will now be described in detail with reference to the annexed drawing, where the present embodiment is not limiting the scope of the present invention but is given only as an illustrative purpose.

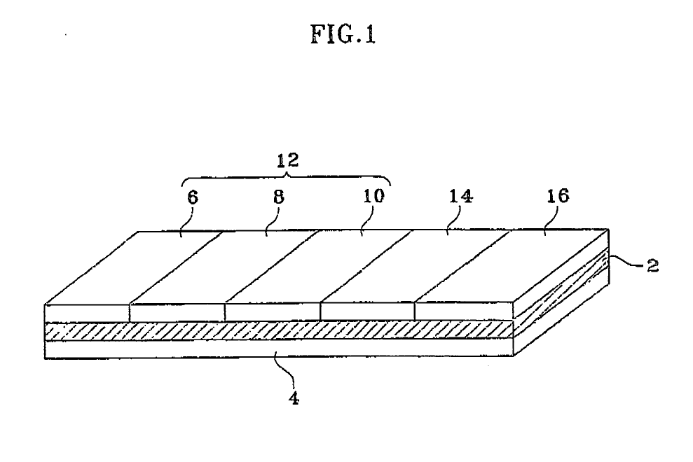

Referring to FIG. 1, the thermal transfer ribbon according to the present invention generally includes a substrate (2), a thin beat-resistant layer (4) coated on one surface of the substrate (2) for preventing thermofusibility between the substrate and a thermal transfer head. A sublimable dye layer (12), a thermofusible ink layer (14) and a protective layer (16) are selectively formed on the other surface of the substrate (2) just by one layer as needed.

In other words, the other surface of the substrate (2) facing the heat-resistant layer (4) may vary in construction thereof according to use.

For example, in case of printing black and white characters and text only, the substrate (2) may be coated only with the thermofusible ink layer (14), or only with the thermofusible ink layer (14) and the protective layer (16). In case of printing color images and characters, the substrate (2) may be formed only with the sublimable dye layer (12) and the protective layer (16), only with the thermofusible ink layer (14) and the sublimable dye layer (12), or with the thermofusible ink layer (14), the sublimable dye layer (12) and the protective layer (16).

At, this time, the thermofusible ink layer (14) and/or the protective layer (16) are made to contain luminescence, invisible fluorescence or mixture thereof to construct the thermal transfer ribbon of the present invention.

Meanwhile, the sublimable dye layer (12) includes yellow (6), magenta (8) and cyan (10).

Hereinafter, the embodiment of the present invention will be described. However, as explained in the foregoing, the embodiment is not limiting the scope of the present invention but is given only as an illustrative purpose and for detailed explanation.

### First Embodiment

A PET film of 5.7 μm coated on the back thereof with a silicon derivative for heat-resistance is coated with an ink composition, as shown in TABLE 1, in the dry coated amount of 1.0 g/m² by way of a gravure printer to thereby manufacture a thermal transfer ribbon equipped with a forgery prevention function according to the present invention.

TABLE 1
(INK LAYER COMPOSITION)

| | Ink layer |
|---|---|
| INK LAYER COMPOSITION | (weight %) |
| PIGMENT (Korea LG Chemical, HI-Black 30B) | 6.5 |
| BINDER RESIN | |
| Acrylic resin (Mitsubishi Rayon, MB-2388) | 3.5 |
| Epoxy resin (Kumho Shell Chemical, E-3002) | 3.0 |
| LUMINESCENCE (Ukseung Chemical, PANAX | 5.0 |
| Green FB 900) | |
| Methyl ethyl ketone/Toluene = 1/1 | 82.0 |

### Second Embodiment

The same method was used as in the first embodiment but the composition of the ink layer is provided in TABLE 2.

TABLE 2
(INK LAYER COMPOSITION)

| | Ink layer |
|---|---|
| INK LAYER COMPOSITION | (weight %) |
| PIGMENT (Korea LG Chemicals, Hi-BlacK 30B) | 6.0 |
| BINDER RESIN | |
| Acrylic resin (Mitsubishi Rayon, MB-2388) | 3.0 |
| Epoxy Resin (Kumho Shell Chemical E-3002) | 3.0 |
| LUMINESCENCE (Ukseung Chemical, PANAX | 6.0 |
| Green FB 900) | |
| Methyl ethyl ketone/Toluene = 1/1 | 82.0 |

### Third Embodiment

A PET film of 5.7 μm coated on the back thereof with a silicon derivative for heat-resistance is coated with a protective layer composition, as shown in TABLE 3, in the dry coated amount of 2.0 g/m² by way of a gravure printer to thereby manufacture a thermal transfer ribbon equipped with a forgery prevention function according to the present invention.

TABLE 3
(PROTECTIVE LAYER COMPOSITION)

| | Protective |
|---|---|
| PROTECTIVE LAYER COMPOSITION | layer (weight %) |
| BINDER RESIN | |
| Acrylic Resin (Mitsubishi Rayon, MB-2388) | 8.5 |
| Epoxy Resin (Kumho Shell Chemical, E-3002) | 8.0 |
| LUMINESCENCE (Ukseung Chemical, PANAX | 5.5 |
| Green FB 900) | |
| Other additives (Ciba Geigy, Tinuvine 327) | 3.0 |
| Methyl ethyl ketone/Toluene = 1/1 | 75.0 |

### Forth Embodiment

The fourth embodiment has been carried out in the same way as the third embodiment but the composition of the protective layer used is provided in TABLE 4.

TABLE 4
(PROTECTIVE LAYER COMPOSITION)

| | Protective layer |
|---|---|
| PROTECTIVE LAYER COMPOSITION | (weight %) |
| BINDER RESIN | |
| Acrylic Resin (Mitsubishi Rayon, MB-2388) | 8.0 |
| Epoxy Resin (Kumho Shell Chemical, E-3002) | 7.5 |
| LUMINESCENCE (Ukseung Chemical, PANAX | 6.5 |
| Green FB 900) | |
| Other Additives (Ciba Geigy,Tinuvine 327) | 3.0 |
| Methyl ethyl ketone/Toluene = 1/1 | 75.0 |

When printing is carried out using a thermal transfer ribbon including a thermofusible ink layer or a protective layer containing luminescence, invisible fluorescence or mixture thereof, there is an advantage in that a security function for preventing forgery and alteration is added simultaneously with the printing to thereby allow the ribbon to be equipped with the security function to a printing material in a simple process.

The foregoing description of the preferred embodiment of the present invention has been presented for the purpose of illustration and description. It is not intended to be exhaustive or to limit the invention to the precise form disclosed, and modifications and variations are possible in the light of the above teachings or may be acquired from practice of the invention. It is intended that the scope of the invention be defined by the claims appended hereto, and their equivalents.

What is claimed is:

1. A thermal transfer ribbon for forgery and counterfeit prevention comprising:
a substrate film;
a heat-resistant layer coated on one surface of said substrate film for preventing thermofusibility between the substrate and a thermal transfer head;
one or more than one thermofusible ink layer, or one or more than one thermofusible ink layer and one or more than one protective layer coated on the other surface of said substrate film just by one layer; and
if necessary one or more than one sublimable dye layer, wherein said thermofusible ink layer and/or said protective layer contain luminescence, invisible fluorescence or mixture thereof.

2. The thermal transfer ribbon as defined in claim 1, wherein said ribbon comprises:
one or more than one thermofusible ink layer;
one or more than one thermofusible ink layer and one or more than one protective layer;
one or more than one thermofusible ink layer and one or more than one sublimable dye layer; or
one or more than one thermofusible ink layer, one or more than one protective layer and one or more than one sublimation ink layer on the other surface of said substrate film just by one layer.

3. The thermal transfer ribbon as defined in claim 1, wherein said thermofusible ink layer contains luminescence, invisible fluorescence or mixture thereof.

4. The thermal transfer ribbon as defined in claim 3, wherein the content of the luminescence, invisible fluorescence or mixture thereof is in the range of 0.5-50 weight % based on the total weight of said thermofusible ink layer.

5. The thermal transfer ribbon as defined in claim 1, wherein said ribbon contains one or more than one protective layer wherein said protective layer contains luminescence, invisible fluorescence or mixture thereof.

6. The thermal transfer ribbon as defined in claim 5, wherein the content of the luminescence, invisible fluorescence or mixture thereof is in the range of 0.5-50 weight % based on the total weight of said protective layer.
